(19) United States
(12) Patent Application Publication
(10) Pub. No.: US 2013/0335320 A1
(43) Pub. Date: Dec. 19, 2013

(54) REMOTE CONTROL COMMUNICATION DEVICE AND NAVIGATION DEVICE

(71) Applicants: Yoshihiko Mori, Tokyo (JP); Masahiro Abukawa, Tokyo (JP)

(72) Inventors: Yoshihiko Mori, Tokyo (JP); Masahiro Abukawa, Tokyo (JP)

(73) Assignee: MITSUBISHI ELECTRIC CORPORATION, Tokyo (JP)

(21) Appl. No.: 14/002,517

(22) PCT Filed: May 13, 2011
(86) PCT No.: PCT/JP2011/002676

§ 371 Date: Aug. 30, 2013

(51) Int. Cl. G06F 13/00

(52) U.S. Cl. CPC G06F 13/00
USPC 345/156

(57) ABSTRACT

Disclosed is a remote control communication device including a data generating unit 107 for generating virtual image data imitating an interface not existing in a remote device 2 of type determined in such a way that the interface can be operated in the remote device 2; a data processing unit 108 for processing image data for remote devices in which the virtual image data is included in image data of a display unit 101 in such a way that the image data for remote devices is suited to a display screen of the remote device 2, and for transmitting the processed image data for remote devices to the remote device 2; and a control unit 111 for, when receiving operation information about an operation which is performed on the basis of the image data for remote devices in the remote device, performing an operation in the interface according to the operation information.

### FIELD OF THE INVENTION

The present invention relates to a remote control communication device that is controlled from a distant point by a remote device, and a navigation device to which this remote control communication device is applied.

### BACKGROUND OF THE INVENTION

Conventionally, software for remote control, which is called VNC (Virtual Network Computing), has been provided. Most of pieces of VNC software hold a function that conforms to a general-purpose communications protocol for remote control which is called an RFB (Remote Frame Buffer) protocol. The RFB protocol and VNC that conforms to this RFB protocol are typically used between PCs installed at a distant from each other in many cases (for example, refer to patent reference 1). Therefore, standards ready for PCs, such as an exchange of monitor sizes and an exchange of information inputted from devices including a mouse, a keyboard, and so on, are defined in the RFB protocol.

### RELATED ART DOCUMENT

### Patent Reference

Patent reference 1: Japanese Unexamined Patent Application Publication No. 2010-157240
Patent reference 2: Japanese Unexamined Patent Application Publication No. 2007-157050

### SUMMARY OF THE INVENTION

### Problems to be Solved by the Invention

As mentioned above, because the RFB protocol and VNC that conforms to this RFB protocol are typically used between PCs in many cases, the standards are designed in such a way as to be easy for PCs to use. It is further assumed that, also when a PC is controlled remotely by using a remote device different from PCs, this remote device has an operation system compatible with PCs. Therefore, no matter what device is chosen as the remote device, the remote control is handled by using an identical interface.

A problem is therefore that in a case of applying such VNC just as it is, and trying to remotely control a server which has an operation system and a display system different from those of a PC and which is not standard (e.g., a vehicle-mounted unit) by using a remote device which is another device and which is not standard (e.g., a mobile terminal), it is difficult for a user to perform an operation because of, for example, a difference in screen size between the server and the remote device. Another problem is that operation buttons or the like disposed outside the screen of the display unit of the server cannot be operated in the remote device.

Further, in the case of using VNC, a remote control operation is performed on one display image data in terms of its properties. A problem is therefore that the server cannot be operated while different display image data are displayed on the server and on the remote device, respectively. For example, a function of, when a user operates a vehicle-mounted unit by using a mobile terminal, displaying map image data on the vehicle-mounted unit and also displaying music selection image data for the vehicle-mounted unit on the mobile terminal, and enabling the user to use the mobile terminal to perform a music selection on the vehicle-mounted unit cannot be implemented.

On the other hand, as one method for solving these problems, there can be provided a method of using software using a specially-designed protocol for remote control. However, in this case, devices that conform to the special protocol have to be provided, and a problem remains unsolved in the connectivity between them. Further, the remote device described in patent reference 1 makes a change or the like of its screen size. However, in this case, it is necessary to provide an extension in the functions of the remote device, and the compatibility with a general-purpose remote device which does not have such a function is lost. A problem is therefore that a general-purpose remote device cannot be used.

The present invention is made in order to solve the above-mentioned problems, and it is therefore an object of the present invention to provide a remote control communication device and a navigation device that can implement a VNC function by using a device which is different from PCs and which is not standard without developing any special protocol and providing any expansion in the functions of a remote device, thereby being able to improve the connectivity and the ease of use of the remote device.

### Means for Solving the Problem

In accordance with the present invention, there is provided a remote control communication device including: a display unit for displaying image data; an image information acquiring unit for acquiring image information about the image data displayed on a screen of the display unit; a communication unit for carrying out communications with a remote device; a remote device determining unit for determining a type of the remote device; a data generating unit for generating virtual image data imitating an interface of the remote control communication device, the interface not existing in the remote device of the type determined by the remote device determining unit, in such a way that the interface can be operated in the above-mentioned remote device; a data processing unit for processing image data for remote devices in which the virtual image data generated by the data creating unit are included in the image data of the display unit which is shown by the image information acquired by the image information acquiring unit in such a way that the image data for remote devices is suited to a display screen of the remote device of the type determined by the remote device determining unit, and for transmitting the processed image data for remote devices to the above-mentioned remote device by using the communication unit; and a control unit for, when the communication unit receives operation information about an operation which is performed on a basis of the image data for remote devices in the remote device, performing an operation in the interface of the remote control communication device according to the above-mentioned operation information.

### Advantages of the Invention

Because the remote control communication device in accordance with the present invention is constructed as above, the remote control communication device can implement a VNC function by using a device which is different from PCs and which is not standard without developing any special protocol and providing any expansion in the functions of the remote device, thereby being able to improve the connectivity and the ease of use of the remote device. Further, because the server (remote control communication device) generates and processes display image data suited to the remote device and transmits the display image data to the remote device, the ease of use of the remote device can be improved as compared with a case of using a general VNC function.

### BRIEF DESCRIPTION OF THE FIGURES

FIG. 1 is a diagram showing an outline of the operation of a remote control communication system in accordance with Embodiment 1 of the present invention;

FIG. 2 is a block diagram showing the structure of the remote control communication system in accordance with Embodiment 1 of the present invention;

FIG. 3 is a sequence diagram of the remote control communication system in accordance with Embodiment 1 of the present invention;

FIG. 4 is a diagram explaining generation of virtual image data for a remote device and processing of image data for remote devices which are carried out by a server in accordance with Embodiment 1 of the present invention;

FIG. 5 is a sequence diagram of a remote control communication system in accordance with Embodiment 2 of the present invention;

FIG. 6 is a diagram explaining generation of virtual image data and processing of image data for remote devices which are carried out by a server in accordance with Embodiment 2 of the present invention;

FIG. 7 is a sequence diagram of a remote control communication system in accordance with Embodiment 3 of the present invention;

FIG. 8 is a diagram explaining generation of virtual image data and processing of image data for remote devices which are carried out by a server in accordance with Embodiment 3 of the present invention;

FIG. 9 is a sequence diagram of a remote control communication system in accordance with Embodiment 4 of the present invention;

FIG. 10 is a diagram explaining generation of virtual image data and processing of image data for remote devices which are carried out by a server in accordance with Embodiment 4 of the present invention;

FIG. 11 is a sequence diagram of a remote control communication system in accordance with Embodiment 5 of the present invention;

FIG. 12 is a diagram explaining generation of virtual image data and processing of image data for remote devices which are carried out by a server in accordance with Embodiment 5 of the present invention;

FIG. 13 is a diagram explaining generation of virtual image data and processing of image data for remote devices which are carried out by a server in accordance with Embodiment 6 of the present invention;

FIG. 14 is a block diagram showing the structure of a remote control communication system in accordance with Embodiment 7 of the present invention;

FIG. 15 is a diagram showing a process of smoothing image data for remote devices which is carried out by a server in accordance with Embodiment 7 of the present invention;

FIG. 16 is a diagram showing determination of division and transmission order of image data for remote devices which is carried out by a server in accordance with Embodiment 8 of the present invention;

FIG. 17 is a block diagram showing the structure of a remote control communication system in accordance with Embodiment 9 of the present invention; and

FIG. 18 is a diagram explaining generation of virtual image data and processing of image data for remote devices which are carried out by a server in accordance with Embodiment 9 of the present invention.

### EMBODIMENTS OF THE INVENTION

Hereafter, in order to explain this invention in greater detail, the preferred embodiments of the present invention will be described with reference to the accompanying drawings.

### Embodiment 1

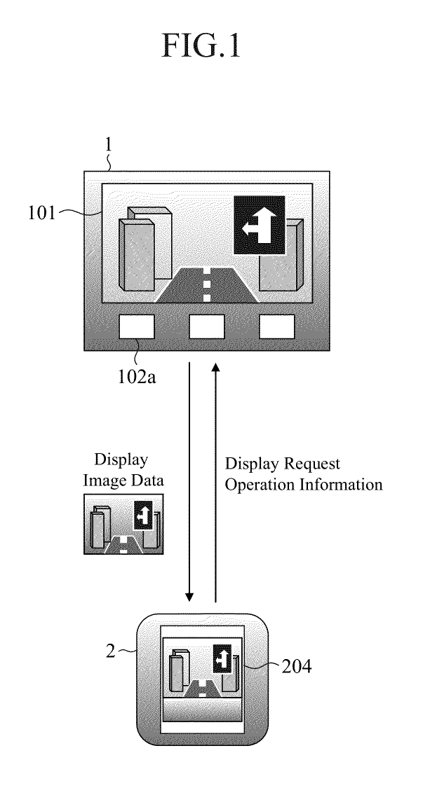

Hereafter, a case in which a vehicle-mounted unit (navigation device) 1 is controlled remotely by a remote device 2, such as a mobile terminal, will be explained. A remote control communication system is comprised of the vehicle-mounted unit 1 which is a server (remote control communication device), and the remote device 2 which is a client terminal that remotely controls this vehicle-mounted unit 1, as shown in FIG. 1. A display unit 101 and various operation buttons 102a located outside the screen of the display unit 101 are disposed in the vehicle-mounted unit 1. Further, a display unit 204 is disposed in the remote device 2. The vehicle-mounted unit 1 and the remote device 2 are connected to each other via communications. Although it is assumed that radio communications are used as the communications, the communications between them is not limited to radio communications. Even if the vehicle-mounted unit and the remote device are connected to each other via cable communications, the communications between them can be processed similarly. Further, a VNC function of performing a remote control operation is mounted in each of the vehicle-mounted unit 1 and the remote device 2. Although the RFB protocol is typically used in order to implement this VNC function, the protocol for use in the VNC function is not limited to this RFB protocol, and another general-purpose protocol can be alternatively used.

The vehicle-mounted unit 1 generates and processes display image data (image data for remote devices) which is suited to the remote device 2 in response to a request from the remote device 2, and transmits the display image data to the remote device 2. The remote device 2 then displays the display image data received thereby on the display unit 204, and transmits operation information about an operation which is performed by a user on the basis of this display image data to the vehicle-mounted unit 1. The vehicle-mounted unit 1 then performs an operation in its own interface according to the operation information, so that the vehicle-mounted unit is remotely controlled by the remote device. Next, the structure of the vehicle-mounted unit 1 and the structure of the remote device 2 will be explained.

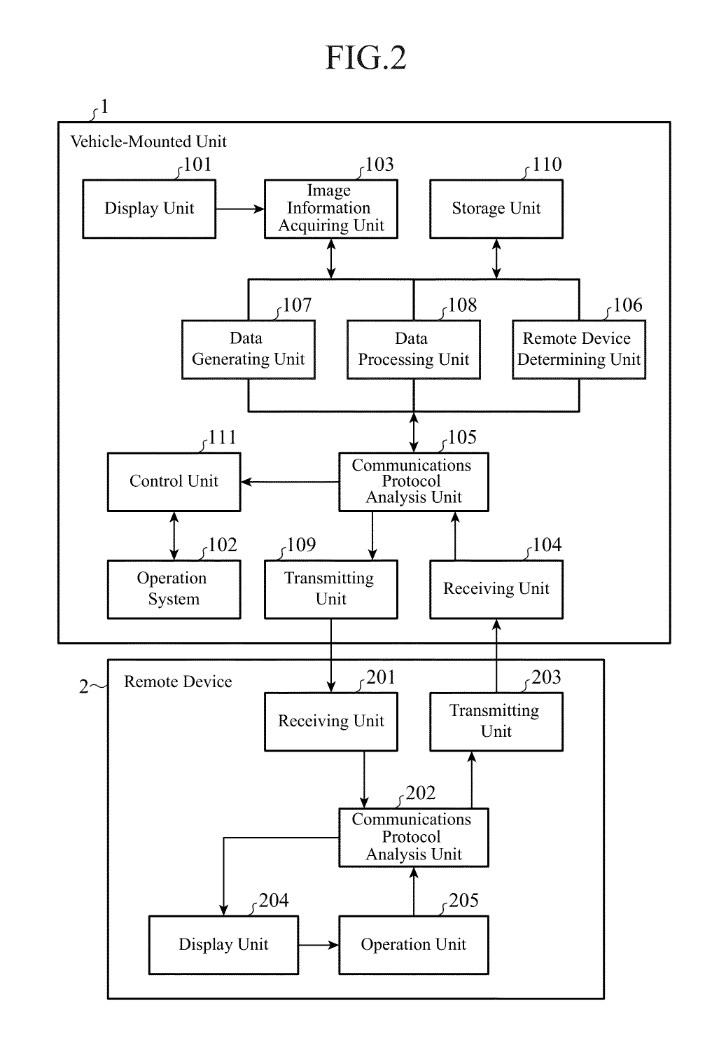

The vehicle-mounted unit 1 is comprised of a display unit 101, an operation system (operation unit) 102, an image information acquiring unit 103, a receiving unit (communication unit) 104, a communications protocol analysis unit 105, a remote device determining unit 106, a data generating unit 107, a data processing unit 108, a transmitting unit (communication unit) 109, a storage unit 110, and a control unit 111, as shown in FIG. 2.

The display unit 101 displays image picture data (display image data), such as map image data and music selection image data. The operation system 102 is comprised of a virtual operation system, such as operation button images existing on the display image data displayed on the display unit 101, and a physical operation system, such as operation buttons 102a disposed outside the screen of the display unit 101. When a button image or an operation button is selected and pushed down by the user, the he vehicle-mounted unit performs an operation which is assigned to the button image or the operation button in advance.

The image information acquiring unit 103 acquires image information about the display image data displayed on the display unit 101. In this case, the image information includes the display image data itself currently being displayed on the display unit 101, typical analysis information of the display image data (the screen size of the display image data, a histogram of the display image data, etc.), and the result of temporarily processing the display image data by using a typical method (a histogram of the display image data on which a smoothing process has been carried out, etc.).

The receiving unit 104 receives a message from the remote device 2. The communications protocol analysis unit 105 carries out an analysis of the message from the remote device 2 which the communications protocol analysis unit has acquired via the receiving unit 104, and generates a message to be transmitted to the remote device 2 via the transmitting unit 109. The remote device determining unit 106 determines the type of the remote device 2 on the basis of the message from the remote device 2 which the remote device determining unit has acquired via the communications protocol analysis unit 105.

The data generating unit 107 dynamically generates appropriate image picture data (virtual image data) imitating the interface of the vehicle-mounted unit which does not exist in the remote device 2 of the determined type in such a way that the interface can be controlled by this remote device 2 on the basis of the type determination result acquired by the remote device determining unit 106, the image information acquired by the image information acquiring unit 103, and so on by using data parts stored in the storage unit 110. The data generating unit 107 generates virtual image data imitating the physical operation system disposed outside the screen of the display unit 101 by using the data parts stored in the storage unit 110.

The data processing unit 108 processes the display image data (image data for remote devices) in which the virtual image data generated by the data generating unit 107 is included in the display image data shown by the acquired image information in such a way that the display image data is suited to the display screen of the remote device 2 of the determined type on the basis of the type determination result acquired by the remote device determining unit 106, the image information acquired by the image information acquiring unit 103, and so on. The data processing unit 108 adds the virtual image data generated by the data generating unit 107 to the display image data currently being displayed on the display unit 101.

The transmitting unit 109 transmits the message generated by the communications protocol analysis unit 105 and the display image data processed by the data processing unit 108 to the remote device 2. The storage unit 110 stores the data parts for use in the data generating unit 107, and other required information (map image data, etc.).

When the communications protocol analysis unit 105 determines that the vehicle-mounted unit has received a message showing operation information, the control unit 111 controls the operation system 102 to perform an operation in the interface of the vehicle-mounted unit according to this operation information. At this time, when the operation information shows an operation on the virtual image data (virtual operation system) included in the display image data currently being displayed on the remote device 2, the control unit 111 performs an operation in this virtual operation system according to the operation information. In contrast, when the operation information shows an operation on the virtual operation system of the original display image data (display image data currently being displayed on the display unit 101), the control unit performs an operation in this virtual operation system according to the operation information.

Next, the structure of the remote device 2 will be explained. The remote device 2 is comprised of a receiving unit 201, a communications protocol analysis unit 202, a transmitting unit 203, a display unit 204, and an operation unit 205, as shown in FIG. 2. The remote device 2 has only to be a general-purpose one having a VNC function.

The receiving unit 201 receives display image data (image data for remote devices) and a message from the vehicle-mounted unit 1. The communications protocol analysis unit 202 carries out an analysis of the message which the communications protocol analysis unit has acquired from the vehicle-mounted unit 1 via the receiving unit 201, and generation of a message to be transmitted to the vehicle-mounted unit 1 via the transmitting unit 203. The communications protocol analysis unit 202 also carries out generation of a message showing operation information accepted by the operation unit 205.

The transmitting unit 203 transmits the message generated by the communications protocol analysis unit 202 to the vehicle-mounted unit 1. The display unit 204 displays the display image data which the display unit has acquired from the vehicle-mounted unit 1 via the communications protocol analysis unit 202. The operation unit 205 accepts an operation from the user on the display image data currently being displayed on the display unit 204. This operation unit 205 is comprised of, for example, a touch panel or the like.

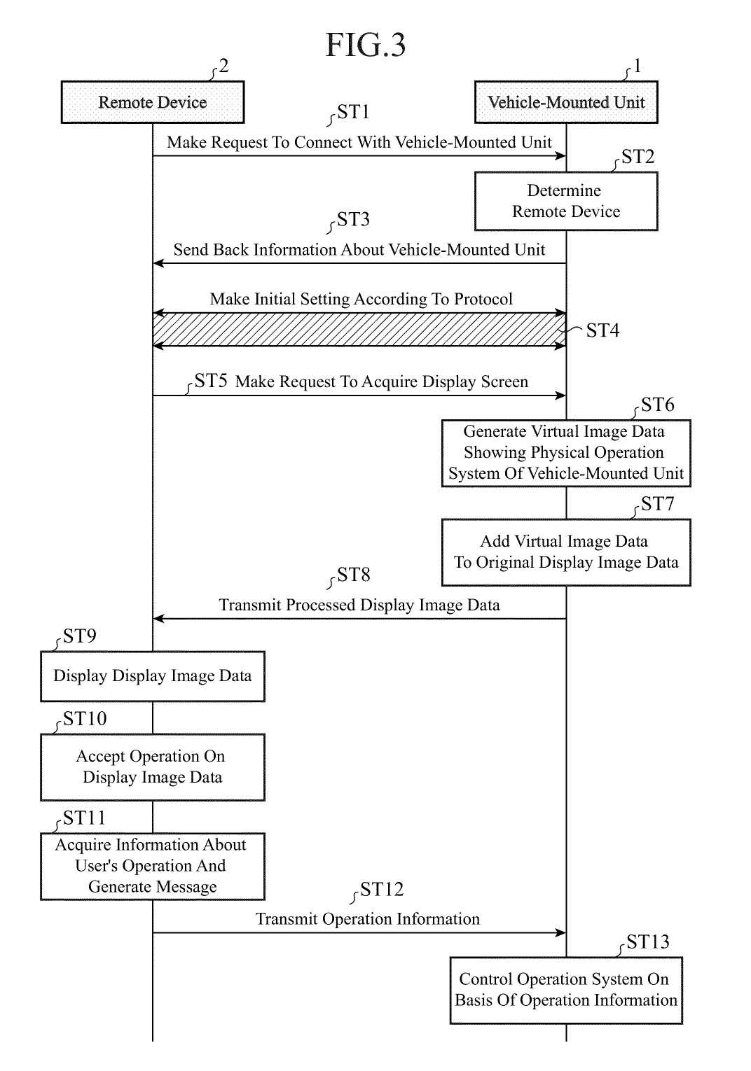

Next, the operation of the remote control communication system constructed as above will be explained. In the operation of the remote control communication system, the remote device 2 transmits a message showing a connection request to the vehicle-mounted unit 1 first (step ST1), as shown in FIG. 3. More specifically, when a user performs an operation of making a connection request to connect with the vehicle-mounted unit 1 via the operation unit 205, the communications protocol analysis unit 202 generates a message showing the connection request to connect with the vehicle-mounted unit 1 first. The transmitting unit 203 then transmits this message to the vehicle-mounted unit 1. Although the transmission protocol is not limited to a specific protocol, the TCP/IP protocol is usually assumed to be used.

The vehicle-mounted unit 1 then identifies the type of this remote device 2 on the basis of the message from the remote device 2 (step ST2). More specifically, the receiving unit 104 receives the message from the remote device 2 first. The communications protocol analysis unit 105 then analyzes this message and determines that the message shows a connection request. The remote device determining unit 106 then determines the type of the remote device 2 on the basis of this message. A method of determining the type of the remote device 2 which the remote device determining unit 106 uses is not limited to a specific method. For example, a method of using an IP of the remote device 2 can be provided. In an example of a process in this case, an IP predetermined in the remote device 2 is stored in advance in the storage unit 110, and the remote device determining unit determines the type of the remote device by comparing the IP detected from the acquired message with the IP stored in the storage unit. As an alternative, the remote device determining unit can use a method of determining the type of the remote device by using an IP range determined statically or dynamically.

The vehicle-mounted unit 1 then transmits information about itself to the remote device 2 (step ST3). More specifically, the communications protocol analysis unit 105 generates a message showing the information about the vehicle-mounted unit 1 first. The transmitting unit 109 then transmits this message to the remote device 2. When using the RFB protocol, the version information of the server is included in this information about the vehicle-mounted unit 1. However, because the protocol is not limited to any specific protocol, the information about the vehicle-mounted unit 1 transmitted to the remote device 2 is not limited to the above-mentioned information. Then, the vehicle-mounted unit 1 and the remote device 2 exchange initial setting information with each other (step ST4). When using the RFB protocol, the screen size of the vehicle-mounted unit 1 and supported graphics formats of the remote device 2 are included in the initial setting information.

The remote device 2 then transmits a message showing a request to acquire display image data (image data for remote devices) to the vehicle-mounted unit 1 (step ST5). More specifically, the communications protocol analysis unit 202 generates a message showing a request to acquire display image data first. The transmitting unit 203 then transmits this message to the vehicle-mounted unit 1.

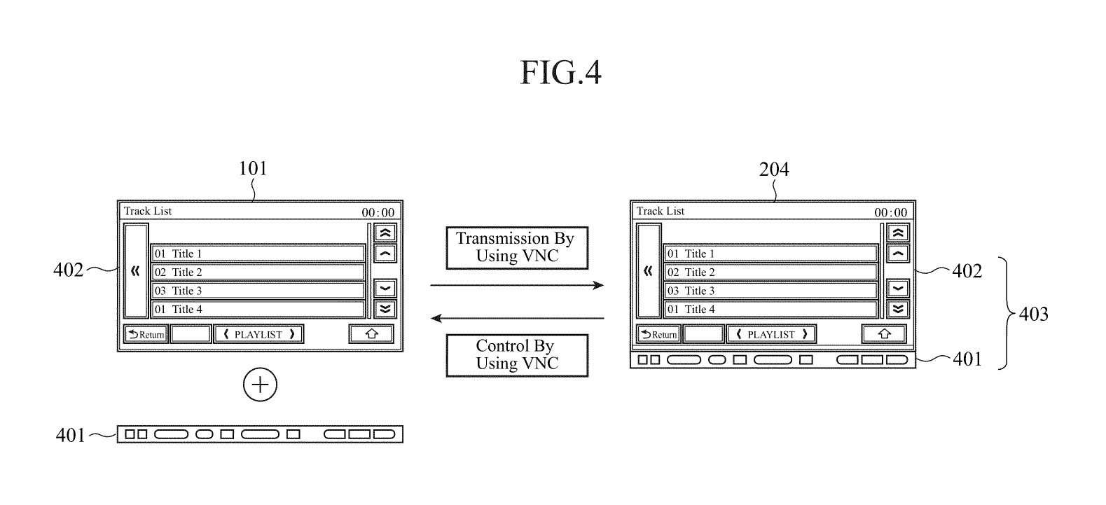

The vehicle-mounted unit 1 then generates virtual image data imitating its own physical operation system (step ST6). More specifically, the receiving unit 104 receives a message from the remote device 2 first. The communications protocol analysis unit 105 then analyzes this message, and determines that the message shows a request to acquire display image data. The data generating unit 107 then generates virtual image data imitating the physical operation system disposed outside the screen of the display unit 101 on the basis of the type determination result acquired by the remote device determining unit 106, the image information acquired by the image information acquiring unit 103, and so on by using the data parts stored in the storage unit 110. In this case, the data generating unit 107 can use fixed virtual image data which is preset in advance, or can dynamically change the size of the virtual image data, the arrangement position of each part data, and so on according to the type of the remote device 2, the mode of the vehicle-mounted unit 1, and so on. In FIG. 4, a case in which operation button bar image data 401 about an operation button bar in which various operation buttons 102a disposed outside the screen of the display unit 101 are listed are generated is shown. Further, the screen information acquiring unit 103 can carry out the process of acquiring the image information when receiving this message or at intervals, and can store this image information in the storage unit 110.

The vehicle-mounted unit 1 then adds the generated virtual image data to the display image data currently being displayed on the display unit 101 (step ST7). More specifically, the data processing unit 108 adds the virtual image data generated by the data generating unit 107 to the display image data currently being displayed on the display unit 101 on the basis of the type determination result acquired by the remote device determining unit 106, the image information acquired by the image information acquiring unit 103, and so on. As a method of adding the virtual image data, there are provided, for example, a method of combining the virtual image data with the display image data currently being displayed on the display unit 101, and a method of superimposing the virtual image data on the display image data. For example, a method of using the former method in a case in which the remote device 2 has a relatively large display unit 204, and using the latter method in a case in which the remote device 2 has a small display unit 204 and makes a request to acquire a part of the display image data currently being displayed on the display unit 101 can be provided. The data processing unit 108 further processes the display image data to which the virtual image data is added to image data in a graphics format in which the image can be displayed on the remote device 2 on the basis of the type determination result acquired by the remote device determining unit 106, the image information acquired by the image information acquiring unit 103, and so on. In the example shown in FIG. 4, the display image data 403 in which the operation button bar image data 401 is combined with a lower portion of the display image data 402 currently being displayed on the display unit 101 are shown.

The vehicle-mounted unit 1 then transmits the processed display image data to the remote device 2 (step ST8). More specifically, the transmitting unit 109 transmits the display image data processed by the data processing unit 108 to the remote device 2.

The remote device 2 then displays the display image data from the vehicle-mounted unit 1 (step ST9). More specifically, the receiving unit 201 receives the display image data from the vehicle-mounted unit 1 first. The display unit 204 then displays the display image data which the display unit has acquired via the communications protocol analysis unit 202. Because the display image data which the remote device 2 receives has a graphics format which can be displayed by this remote device 2, no special function has to be mounted in the remote device 2. As a result, the remote device 2 displays the display image data 403 having the operation button bar image data 401 shown in FIG. 4 on the display unit 204 thereof.

The remote device 2 then accepts the user's operation on the display image data currently being displayed (step ST10). More specifically, the operation unit 205 accepts an operation by the user on the display image data currently being displayed on the display unit 204. For example, when selecting an operation button 102a of the vehicle-mounted unit 1 in the display image data 403 shown in FIG. 4, the user selects his or her desired operation button image data on the operation button bar image data 401. On the other hand, when selecting a virtual operation button on the display image data currently being displayed on the vehicle-mounted unit 1, the user selects operation button image data on the display image data 402 as usual. The remote device 2 does not have to have a special function other than the VNC function for this operation process, and can carry out the process within the limit determined by a general-purpose protocol.

The remote device 2 then generates a message showing operation information about the operation, and transmits the message to the vehicle-mounted unit 1 (steps ST11 and ST12). More specifically, the communications protocol analysis unit 202 generates a message showing the operation information about the operation accepted by the operation unit 205. The transmitting unit 203 then transmits this message to the vehicle-mounted unit 1. The remote device 2 does not have to have a special function other than the VNC function for the process of generating and transmitting a message showing this operation information, and can carryout the process within the limit determined by the general-purpose protocol. Further, a message showing this operation information is generated every time when an operation is performed by the user, and is transmitted to the vehicle-mounted unit 1.

The vehicle-mounted unit 1 then controls the operation system 102 of the vehicle-mounted unit 1 on the basis of the operation information from the remote device 2 (step ST13). More specifically, the receiving unit 104 receives the message from the remote device 2 first. The communications protocol analysis unit 105 analyzes this message, and determines that the message shows operation information. The control unit 111 controls the operation system 102 of the vehicle-mounted unit 1 on the basis of this operation information. At this time, when determining that the coordinate position of the operated part included in the operation information falls within the area of the virtual image data (virtual operation system) included in the display image data currently being displayed on the display unit 204, the control unit 111 carries out an operation according to this virtual operation system. More specifically, when a predetermined part (an operation button image) of the operation button bar image data 401 is selected in the example shown in FIG. 4, the control unit determines that the operation button 102a shown by this operation button image has been pushed down, and performs an operation in this operation button 102a according to the operation information. In contrast, when determining that the coordinate position of the operated part falls within a predetermined part (virtual operation system) on the original display image data included in the display image data currently being displayed on the display unit 204 (display image data currently being displayed on the display unit 101), the control unit 111 determines that this virtual operation system has been selected (e.g., touched or clicked), and performs an operation in this operation system according to the operation information.

By performing the controlling operation in this way, even in a case in which the remote device 2 does not have any physical operation system (e.g., operation buttons 102a) disposed outside the screen of the display unit 101, the control unit transmits the virtual image data imitating this physical operation system to enable the remote device 2 to remotely control the physical operation system of the vehicle-mounted unit 1. Further, in this case, the remote device does not have to use any special protocol. Further, no extension does not have to be provided for the functions of the remote device 2, and the remote device 2 has only to have a general-purpose VNC function.

As mentioned above, in the remote control communication system in accordance with this Embodiment 1, the vehicle-mounted unit 1 is constructed in such a way that the vehicle-mounted unit determines the type of the remote device 2, generates virtual image data imitating its own physical operation system disposed outside the screen display data of the display unit 101 on the basis of the type determination result and so on, and transmits the virtual image data to the remote device 2, and, when an operation is performed on the virtual image data in the remote device 2, determines that the corresponding physical operation system has been pushed down. Therefore, in a case of implementing a VNC function between devices which are different from PCs and which are not standard, the virtual operation system equivalent to the physical operation system of the vehicle-mounted unit 1 can be provided for the remote device 2 without developing any special protocol and providing any extension for the remote device 2, thereby being able to improve the connectivity and the ease of use of the remote device. Further, because the vehicle-mounted unit 1 determines the type of the remote device 2 and transmits appropriate display image data to the remote device, the ease of use of the remote device can be improved as compared with a case of using a general VNC function.

Although the operation buttons 102a disposed in the vehicle-mounted unit 1 are explained as the physical operation system in Embodiment 1, this embodiment is not limited to this example. This embodiment can also be similarly applied to a case of using another physical operation system (e.g., a keyboard). Further, although the display image data shown in FIG. 4 is shown by taking the case of adding the virtual image data to the music selection image data used for selecting a musical piece in the vehicle-mounted unit 1 as an example, virtual image data imitating an interface (operation buttons 102a or the like) of the vehicle-mounted unit which is used for navigation processes in such a way that the interface can be operated in the remote device 2 can be added to the display image data (map image data). In this case, when the virtual image data is selected in the remote device 2, the control unit 111 performs an operation regarding a navigation process on the interface of the vehicle-mounted unit according to the operation information.

### Embodiment 2

In Embodiment 1, the case in which the physical operation system, such as operation buttons 102a, disposed in the vehicle-mounted unit 1 is expressed by using virtual image data, just as it is, is shown. In Embodiment 2, a case of changing the display form of this physical operation system to imitate another virtual operation system for enabling a user to operate a physical operation system by using image data is shown. A remote control communication system in accordance with Embodiment 2 has the same structure as that in accordance with Embodiment 1 shown in FIG. 2, and will be explained with reference to this FIG. 2.

A data generating unit 107 dynamically generates virtual image data imitating another virtual operation system for enabling a user to operate a physical operation system of a vehicle-mounted unit 1 on the basis of a type determination result acquired by a remote device determining unit 106, image information acquired by an image information acquiring unit 103, and so on by using data parts stored in a storage unit 110.

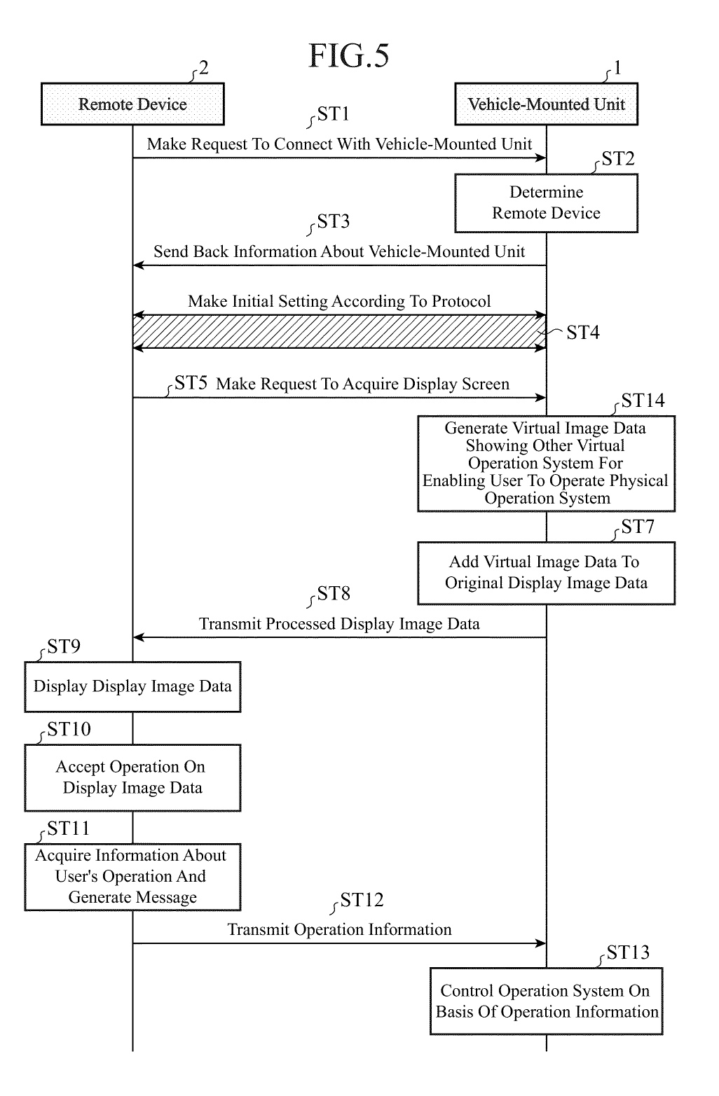

Next, the operation of this remote control communication system will be explained. In the operation of the remote control communication system in accordance with Embodiment 2 shown in FIG. 5, the same processes as those performed by the remote control communication system in accordance with Embodiment 1 shown in FIG. 3 are designated by the same reference characters and the explanation of the processes will be simplified. In the operation of the remote control communication system, the remote control communication system establishes a communication connection between a remote device 2 and the vehicle-mounted unit 1, and determines the type of the remote device 2 (steps ST1 to ST4), as shown in FIG. 5. The remote device 2 then transmits a message showing a request to acquire display image data to the vehicle-mounted unit 1 (step ST5).

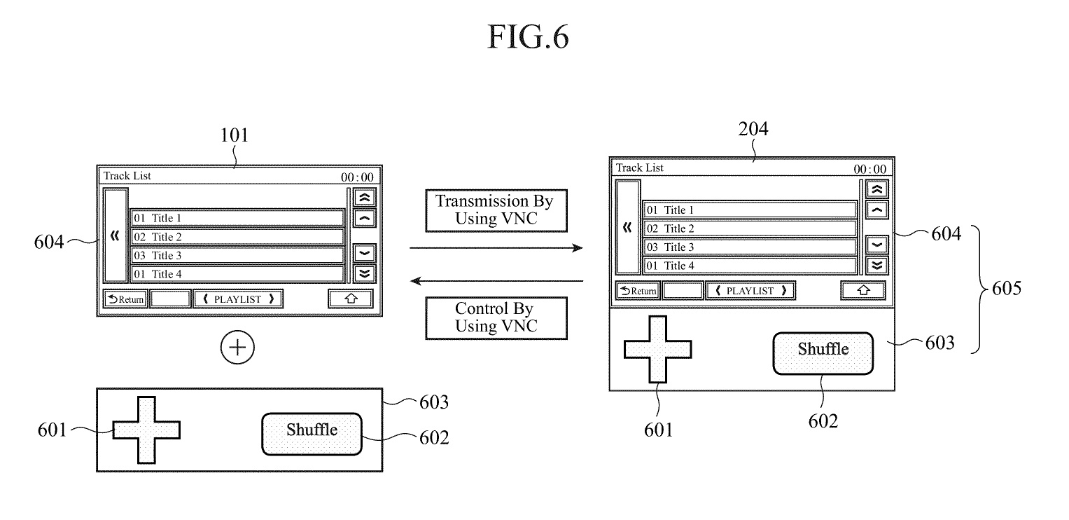

The vehicle-mounted unit 1 then generates virtual image data imitating another virtual operation system for enabling the user to operate its own physical operation system (step ST14). More specifically, instead of faithfully imitating operation buttons 102a actually disposed in the vehicle-mounted unit 1, the data generating unit 107 imitates another virtual operation system, such as a controller, for enabling the user to operate the operation buttons 102a by using virtual image data. As a result, the vehicle-mounted unit 1 can provide either an operation system having a complicated shape, such as a keyboard which does not exist in the vehicle-mounted unit 1, or only operation buttons whose functions are limited to only specific functions for the remote device 2. For example, a method of using the former operation system in a case in which the remote device 2 has a relatively large display unit 204, and using the latter operation buttons in a case in which the remote device 2 has a small display unit 204 can be considered. In this case, the data generating unit 107 can use preset and fixed virtual image data, and can dynamically change the size of the virtual image data, the arrangement position of each part data, and so on according to the type of the remote device 2, the mode of the vehicle-mounted unit 1, and so on. FIG. 6 shows a case in which the data generating unit generates virtual image data 603 including cross key image data 601 for enabling the user to make a music selection and shuffle button image data 602 for enabling the user to cause the vehicle-mounted unit to perform a shuffle play of pieces of music, the cross key image data and the shuffle button image data not existing in the vehicle-mounted unit 1.

The vehicle-mounted unit 1 then adds the generated virtual image data to the display image data currently being displayed on a display unit 101 (step ST7). In the example shown in FIG. 6, the display image data 605 in which the virtual image data 603 is combined with a lower portion of the display image data 604 currently being displayed on the display unit 101 are shown. The vehicle-mounted unit 1 then transmits the processed display image data to the remote device 2 (step ST8). When also generating client SW (software) as well as the virtual image data, the vehicle-mounted unit discriminates this virtual image data from other display image data by, for example, adding a header to the virtual image data or transmitting only a drawing command. Also when producing an enlarged display, a sector display, or the like, the vehicle-mounted unit can cause the remote device to display the virtual image data.

The remote device 2 then displays the display image data from the vehicle-mounted unit 1 (step ST9). As a result, the remote device 2 displays the display image data 605 having the virtual image data 603 (the cross key image data 601 and the shuffle button image data 602) shown in FIG. 6 on the display unit 204 thereof. The remote device 2 then accepts the user's operation on the display image data currently being displayed, generates a message showing operation information about the operation, and transmits the operation information to the vehicle-mounted unit 1 (steps ST10 to ST12).

The vehicle-mounted unit 1 then controls the operation system 102 of the vehicle-mounted unit 1 on the basis of the operation information from the remote device 2 (step ST13). For example, when the shuffle button image data 602 is selected in FIG. 6, a control unit 111 carries out a process of performing a shuffle play of musical pieces.

As mentioned above, because the remote control communication system in accordance with this Embodiment 2 is constructed in such a way that the vehicle-mounted unit 1 generates virtual image data imitating another virtual operation system for enabling a user to operate its own physical operation system disposed outside the screen display data of the display unit 101, and transmits the virtual image data to the remote device 2, the remote control communication system can provide the individual virtual operation system which is suited to the screen size or the like of the remote device 2, and which does not exist in both the vehicle-mounted unit 1 and the remote device 2, and control the restrictions or the like imposed on operations which can be performed in the remote device 2 without developing any special protocol and providing any extension for the remote device 2. Therefore, a natural operation system can be provided for the remote device 2.

### Embodiment 3

In Embodiments 1 and 2, the case of using display image data currently being displayed on the vehicle-mounted unit 1 as a base, adding virtual image data to the display image data, and transmitting the display image data to the remote device 2 is shown. In Embodiment 3, a case of displaying different display image data on a vehicle-mounted unit 1 and on a remote device 2, respectively, and graphically and remotely controlling the vehicle-mounted unit 1 will be shown. A remote control communication system in accordance with Embodiment 3 has the same structure as that in accordance with Embodiment 1 shown in FIG. 2, and will be explained with reference to this FIG. 2.

A data generating unit 107 generates virtual image data showing other display image data different from display image data currently being displayed on a display unit 101 on the basis of a type determination result acquired by a remote device determining unit 106, image information acquired by an image information acquiring unit 103, and so on by using data parts stored in a storage unit 110. Further, a data processing unit 108 processes the virtual image data generated by the data generating unit 107 as image data for remote devices in such a way that the virtual image data is suited to the display screen of the remote device 2 of the type determined by the remote device determining unit 106.

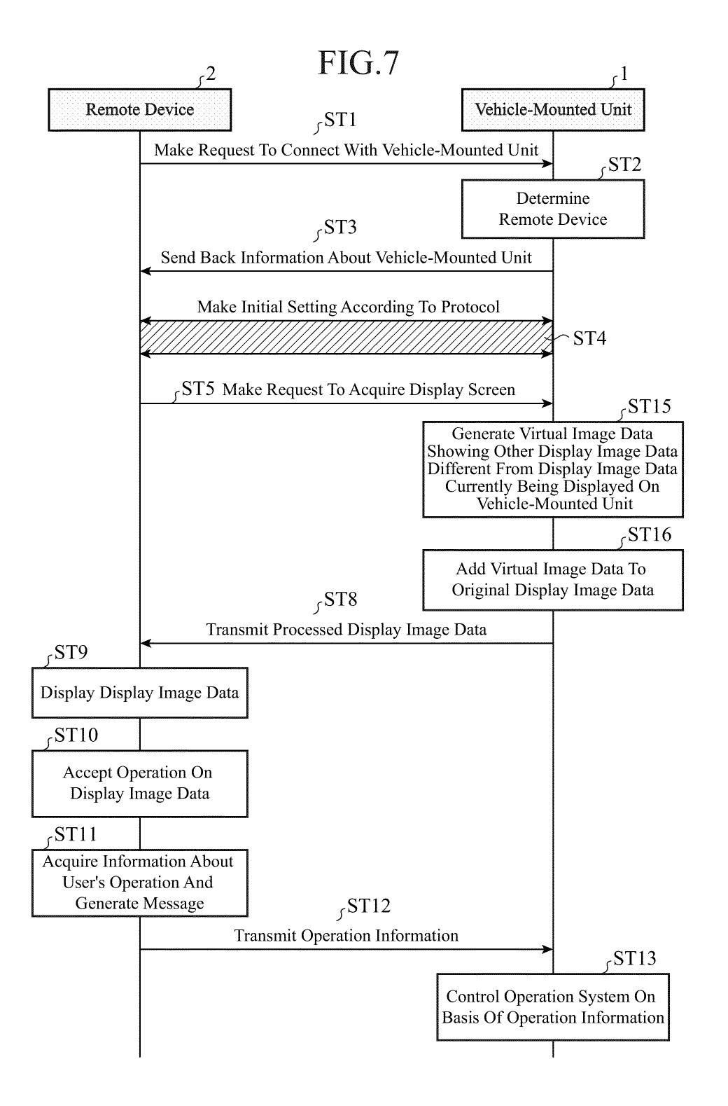

Next, the operation of this remote control communication system will be explained. In the operation of the remote control communication system in accordance with Embodiment 3 shown in FIG. 7, the same processes as those performed by the remote control communication system in accordance with Embodiment 1 shown in FIG. 3 are designated by the same reference characters and the explanation of the processes will be simplified. In the operation of the remote control communication system, the remote control communication system establishes a communication connection between the remote device 2 and the vehicle-mounted unit 1, and determines the type of the remote device 2 (steps ST1 to ST4), as shown in FIG. 7. The remote device 2 then transmits a message showing a request to acquire display image data to the vehicle-mounted unit 1 (step ST5).

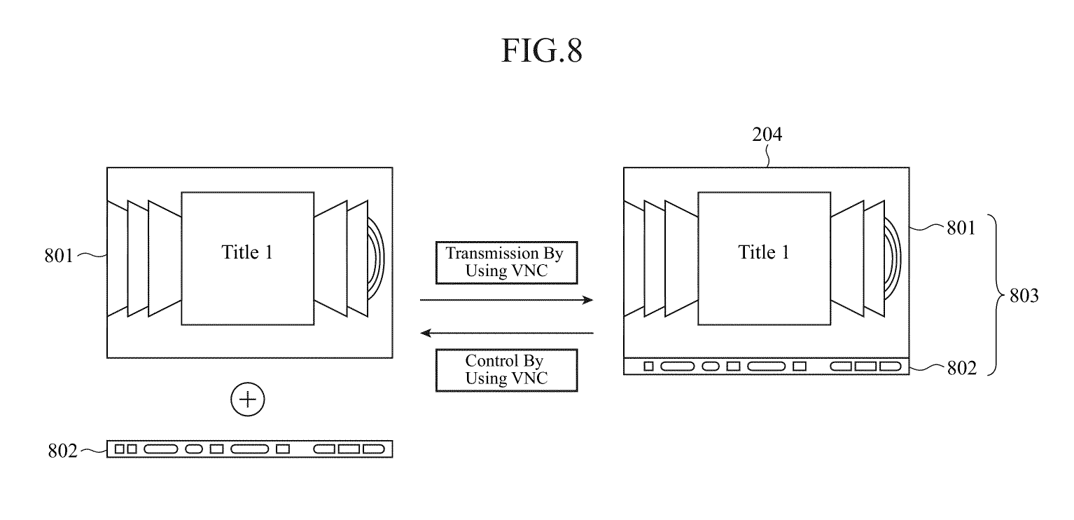

The vehicle-mounted unit 1 then generates virtual image data showing other display image data for enabling a user to operate the vehicle-mounted unit 1 in the remote device 2, the to other display image data being different from the display image data currently being displayed on the display unit 101 (step ST15). More specifically, the data generating unit 107 generates arbitrary display image data which is not the same data as the display image data currently being displayed on the display unit 101, but is customized. For example, when map image data is displayed in the vehicle-mounted unit 1, the remote control communication system displays music selection image data 801 for enabling the user to select a musical piece in the vehicle-mounted unit 1 on the screen of the remote device 2, as shown in FIG. 8. As a result, the remote control communication system makes it possible for the user to perform another remote control operation in the remote device 2 without changing the display screen of the vehicle-mounted unit 1. Therefore, the remote control communication system can provide a UI which is suited to the remote device 2 and which is more sophisticated. In this case, the data generating unit 107 can use preset and fixed virtual image data, and can dynamically change the size of the virtual image data, the arrangement position of each part data, and so on according to the type of the remote device 2, the mode of the vehicle-mounted unit 1, and so on. FIG. 8 shows a case in which the data generating unit generates the music selection image data 801 and operation button bar image data 802 showing a list of operation buttons 102a of the vehicle-mounted unit 1.

The vehicle-mounted unit 1 then processes the generated virtual image data into display image data which is suited to the remote device 2 (step ST17). In the example shown in FIG. 8, the display image data 803 in which the operation button bar image data 802 is combined with a lower portion of the music selection image data 801 generated by the data generating unit 107 are shown. The vehicle-mounted unit 1 then transmits the processed display image data to the remote device 2 (step ST8). When also generating client SW (software) as well as the virtual image data, the vehicle-mounted unit acquires each drawing part by transmitting only a drawing command or transmitting a drawing image asynchronously, and generates a screen by using a drawing chip specific to the remote device 2. In this case, the vehicle-mounted unit 1 can have a form of a server that accepts only a VNC command and makes a state transition. As an alternative, an individual server that can check the state of the remote device 2 can be added as the vehicle-mounted unit.

The remote device 2 then displays the display image data from the vehicle-mounted unit 1 (step ST9). As a result, the remote device 2 can display the display image data 803, as shown in FIG. 8, different from the display image data currently being displayed on the display unit 101 on the display unit 204 thereof. The remote device 2 then accepts the user's operation on the display image data currently being displayed and generates a message showing operation information about the operation, and transmits the message to the vehicle-mounted unit 1 (steps ST10 to ST12).

The vehicle-mounted unit 1 then controls an operation system 102 of the vehicle-mounted unit 1 on the basis of the operation information from the remote device 2 (step ST13). When other display image data different from that of the vehicle-mounted unit 1 is displayed on the remote device 2, and an operation is performed on a predetermined part (a virtual operation system) on this display image data, a control unit 111 performs an operation in this virtual operation system according to the operation information. For example, when a musical piece is selected for the music selection image data 803 shown in FIG. 8, the vehicle-mounted unit 1 plays the music selected while being in a state of displaying map image data.

As mentioned above, because the system in accordance with this Embodiment 3 is constructed in such a way that the vehicle-mounted unit 1 generates virtual image data showing other display image data for enabling a user to operate the vehicle-mounted unit 1 in the remote device 2, the other display image data being different from the display image data currently being displayed on the display unit 101, and transmits the virtual image data to the remote device 2, the information displayed on the vehicle-mounted unit 1 can be made to differ from that displayed on the remote device 2 and a special operation system which is suited to the remote device 2 can be provided for the remote device, and the ease of use of the remote device can be improved. Further, in this embodiment, there is no necessity to develop any protocol, provide any expansion for the functions of the remote device 2, and so on, and the remote device 2 has only to have a general-purpose VNC function.

### Embodiment 4

In a case in which a vehicle-mounted unit 1 is remotely controlled by using a remote device 2, such as a mobile terminal, for example, there is a demand to make the screen sizes of display units 101 and 204 differ from each other, and change the screen size of display image data. Conventionally, to respond to this demand, a remote device carries out a process of changing the screen size of display image data. A problem is therefore that when no function of changing the screen size is mounted in a remote device, this remote device cannot carry out this changing process. To solve this problem, in Embodiment 4, a remote control communication system in which when the screen sizes of display units 101 and 204 differ from each other, a vehicle-mounted unit 1 changes the screen size of display image data will be shown. The remote control communication system in accordance with Embodiment 4 has the same structure as that in accordance with Embodiment 1 shown in FIG. 2, and will be explained with reference to this FIG. 2.

A data processing unit 108 changes the screen size of display image data to be transmitted to a remote device 2 to a screen size which is suited to the remote device 2 on the basis of a type determination result acquired by a remote device determining unit 106, image information acquired by an image information acquiring unit 103, and so on.

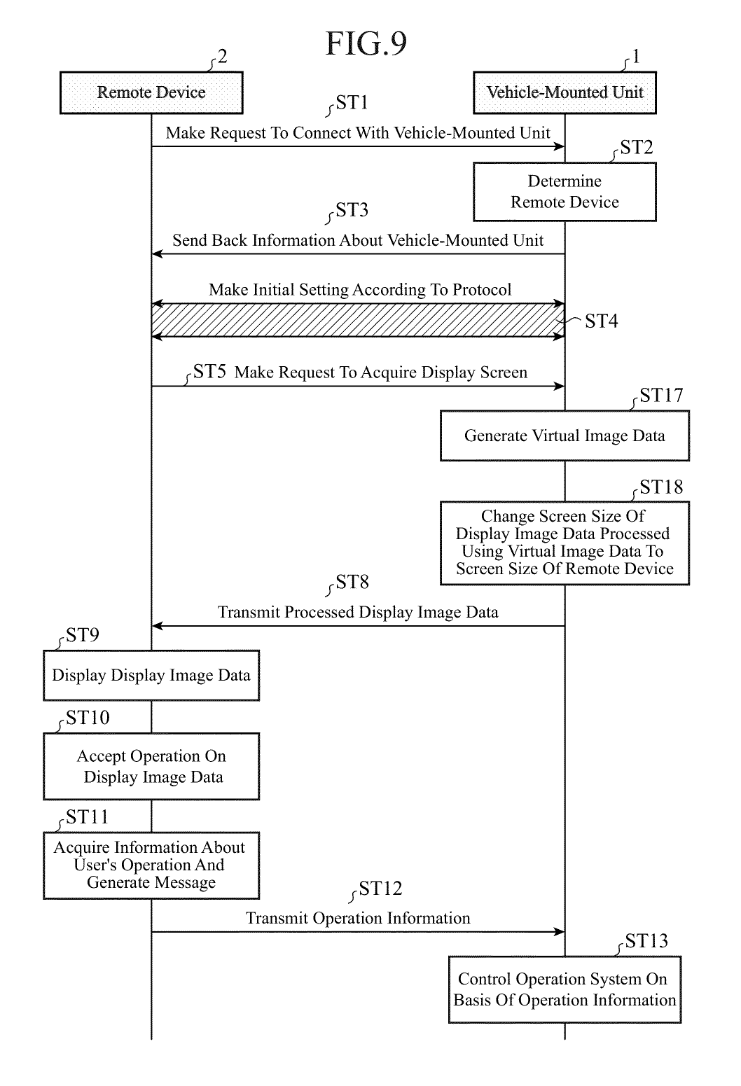

Next, the operation of this remote control communication system will be explained. In the operation of the remote control communication system in accordance with Embodiment 4 shown in FIG. 9, the same processes as those performed by the remote control communication system in accordance with Embodiment 1 shown in FIG. 3 are designated by the same reference characters and the explanation of the processes will be simplified. In the operation of the remote control communication system, the remote control communication system establishes a communication connection between the remote device 2 and the vehicle-mounted unit 1, and determines the type of the remote device 2 (steps ST1 to ST4), as shown in FIG. 9. The remote device 2 then transmits a message showing a request to acquire display image data to the vehicle-mounted unit 1 (step ST5). The vehicle-mounted unit 1 then generates virtual image data for enabling a user to operate the vehicle-mounted unit 1 in the remote device 2 by using the method in accordance with any one of Embodiments 1 to 3 (step ST17).

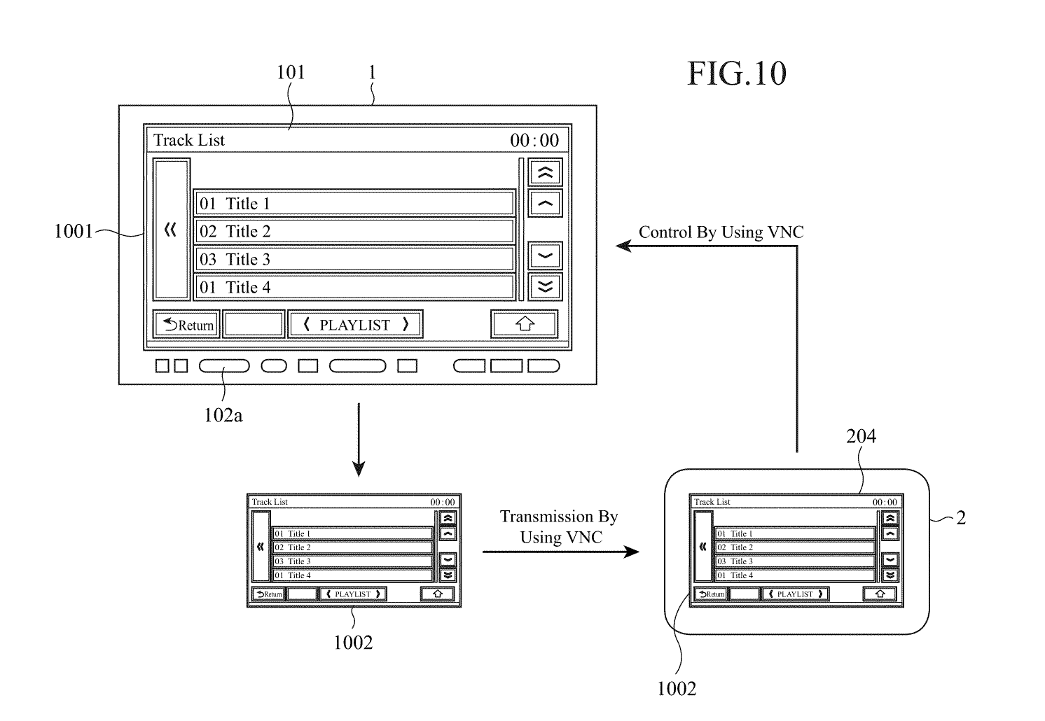

After then processing the generated virtual image data into display image data for the remote device 2 by using the method in accordance with any one of Embodiments 1 to 3, the vehicle-mounted unit 1 changes the screen size of the display image data to a screen size suited to the remote device 2 (step ST18). Enlarging or reducing the screen size of the display image data can be implemented by using a commonly used method. Further, ratios predetermined for each remote device 2 can be used as reducing and enlarging scales, or the reducing and enlarging scales can be dynamically changed on the basis of the screen range of the display image data which is requested by the remote device 2. When the reducing and enlarging scales are dynamically changed, a method of properly computing a scaling factor suited to the screen range which is requested invariably by the remote device can be used, for example. FIG. 10 shows a case in which the screen size of the remote device 2 is smaller than that of the vehicle-mounted unit 1, and the display image data 1001 in which the virtual image data is combined with the display image data currently being displayed on the vehicle-mounted unit 1 is reduced to one-quarter of the original size. The vehicle-mounted unit 1 then transmits the processed display image data to the remote device 2 (step ST8).

The remote device 2 then displays the display image data from the vehicle-mounted unit 1 (step ST9). As a result, the remote device 2 displays the display image data 1002 whose screen size has been changed to the screen size suited to the remote device 2 shown in FIG. 10 on a display unit 204 thereof. The remote device 2 then accepts the user's operation on the display image data currently being displayed and generates a message showing operation information about the operation, and transmits the message to the vehicle-mounted unit 1 (steps ST10 to ST12).

The vehicle-mounted unit 1 then controls an operation system 102 of the vehicle-mounted unit 1 on the basis of the operation information from the remote device 2 (step ST13). In this case, because the vehicle-mounted unit resizes the processed display image data with a proper scaling factor and provides the display image data resized thereby for the remote device 2, a control unit 111 controls the operation system 102 after correcting the coordinate position of an operated part included in the operation information with the scaling factor. For example, because the display image data 1002 which is the display image data 1001 (in which the virtual image data is combined with the original display image data) whose screen size has been reduced to one-quarter of the original size is displayed on the remote device 2 in FIG. 10, the control unit 111 controls the operation system 102 after multiplying the coordinate position of the operated part by a factor of 4.

As mentioned above, because the remote control communication system in accordance with this Embodiment 4 is constructed in such a way that the vehicle-mounted unit changes the screen size of the display image data to a screen size suited to the remote device 2 and transmits the display image data to the remote device 2, the remote device 2 can acquire the display image data whose screen size is suited thereto even in a case in which the remote device 2 does not have any function of changing the screen size thereof, thereby being able to improve the ease of use of the remote device.

### Embodiment 5

In Embodiment 5, a case in which a plurality of display image data which can be displayed on a display unit 101 are combined with one another and are transmitted when the screen size of a remote device 2 is sufficiently larger than that of a vehicle-mounted unit 1 is shown. A remote control communication system in accordance with Embodiment 5 has the same structure as that in accordance with Embodiment 1 shown in FIG. 2, and will be explained with reference to this FIG. 2.

A data generating unit 107 generates at least one virtual image data showing other display image data for enabling a user to operate the vehicle-mounted unit 1 in the remote device 2, the other display image data being different from display image data currently being displayed on the display unit 101, on the basis of a type determination result acquired by a remote device determining unit 106, image information acquired by an image information acquiring unit 103, and so on by using data parts stored in a storage unit 110. Further, a data processing unit 108 combines the virtual image data generated by the data generating unit 107 with the display image data currently being displayed on the display unit 101 on the basis of the type determination result acquired by the remote device determining unit 106, the image information acquired by the image information acquiring unit 103, and so on.

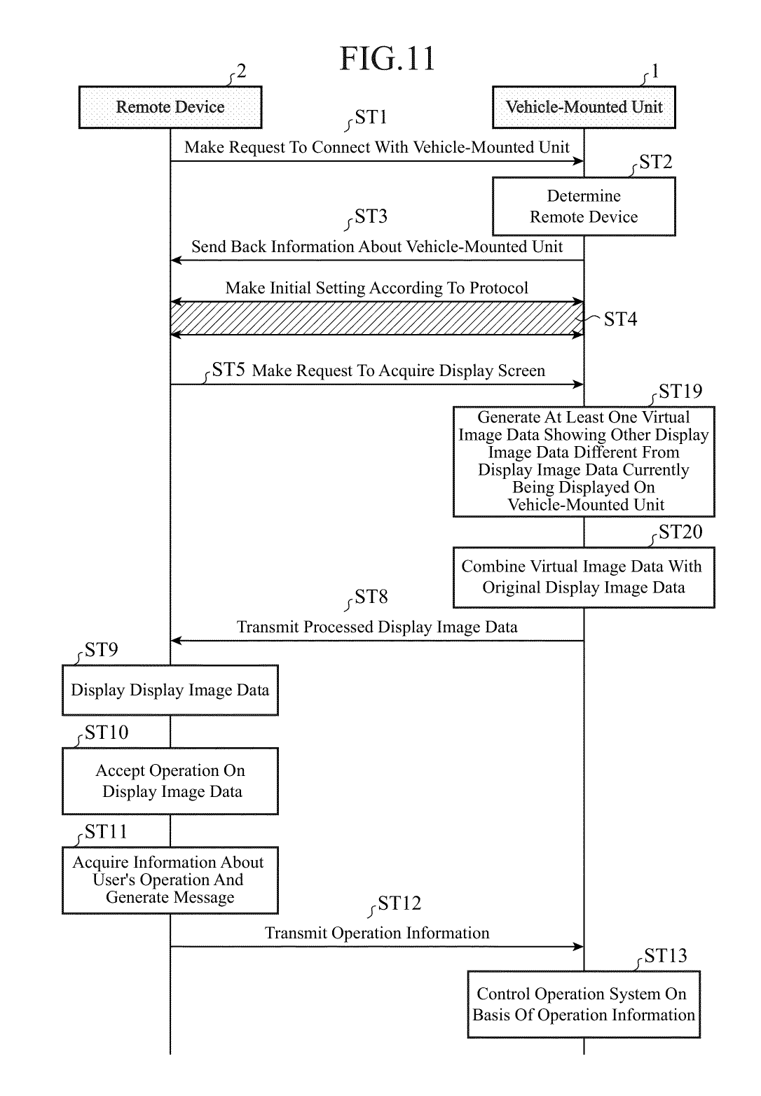

Next, the operation of this remote control communication system will be explained. In the operation of the remote control communication system in accordance with Embodiment 5 shown in FIG. 11, the same processes as those performed by the remote control communication system in accordance with Embodiment 1 shown in FIG. 3 are designated by the same reference characters and the explanation of the processes will be simplified. In the operation of the remote control communication system, the remote control communication system establishes a communication connection between the remote device 2 and the vehicle-mounted unit 1, and determines the type of the remote device 2 (steps ST1 to ST4), as shown in FIG. 11. The remote device 2 then transmits a message showing a request to acquire display image data to the vehicle-mounted unit 1 (step ST5).

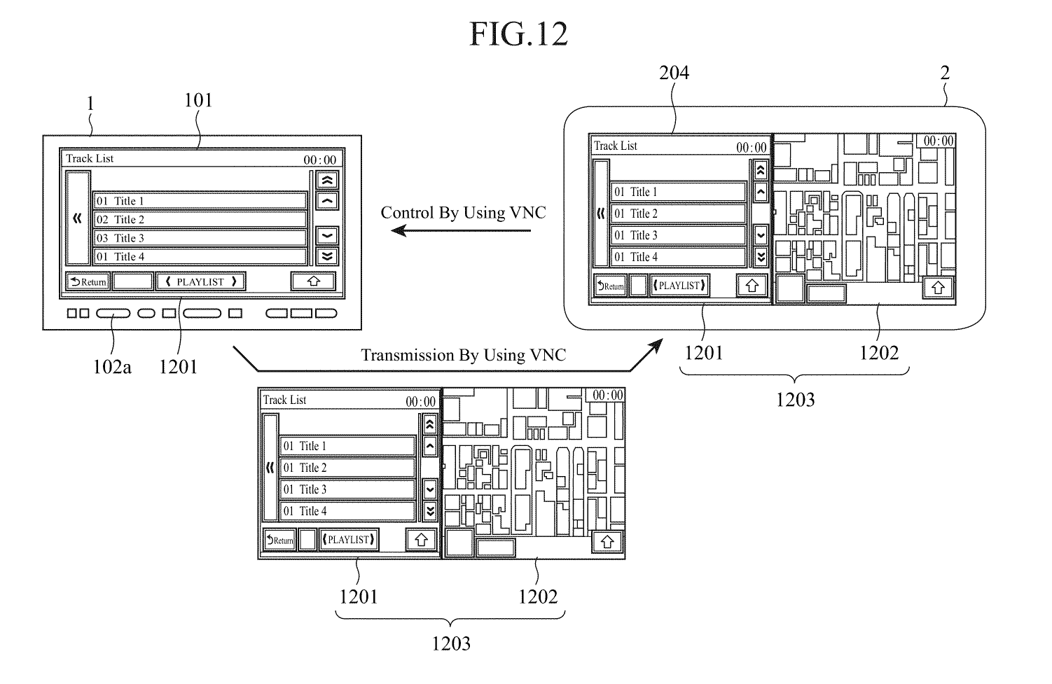

The vehicle-mounted unit 1 then generates at least one virtual image data showing other display image data for enabling the user to operate the vehicle-mounted unit 1 in the remote device 2, the other display image data being different from the display image data currently being displayed on the display unit 101 (step ST19). At this time, the data generating unit 107 can generate display image data newly, or can store display image data that was displayed on the display unit 101 in the past (e.g., the last displayed display image data) in the storage unit 110 and use the display image data. FIG. 12 shows a case in which map image data 1202 different from music selection image data 1201 currently being displayed on the display unit 101 is generated is shown.

The vehicle-mounted unit 1 then combines the display image data currently being displayed on the display unit 101 and the generated virtual image data into display image data, and processes this display image data into display image data which is suited to the remote device 2 (step ST20). In this case, as a method of combining a plurality of display image data, there is a method of, when, for example, four display image data are provided, reducing the size of each of the four display image data to one-quarter of the original size, and placing the four display image data at an upper left position, an upper right position, a lower left position, and a lower right position, respectively, to combine them into display image data. FIG. 12 shows display image data 1203 in which the music selection image data 1201 currently being displayed on the display unit 101 whose size is reduced to one-half of the original size and the generated map image data 1202 whose size is also reduced to one-half of the original size are combined with each other.

The vehicle-mounted unit 1 then transmits the processed display image data to the remote device 2 (step ST8). The remote device 2 then displays the display image data from the vehicle-mounted unit 1 (step ST9). As a result, the remote device 2 can display the display image data 1203, as shown in FIG. 12, in which the music selection image data 1201 currently being displayed on the display unit 101 and the map image data 1202 not being displayed on the display unit 101 are arranged in parallel to each other on a display unit 204 thereof. The remote device 2 then accepts the user's operation on the display image data currently being displayed and generates a message showing operation information about the operation, and transmits the message to the vehicle-mounted unit 1 (steps ST10 to ST12).

The vehicle-mounted unit 1 then controls an operation system 102 of the vehicle-mounted unit 1 on the basis of the operation information from the remote device 2 (step ST13). In this case, because the remote device 2 provides the data in which the plurality of display image data for enabling the user to operate the vehicle-mounted unit 1 are combined with one another for the user, a control unit 111 controls the operation system 102 after determining on which display image data the operation has been performed on the basis of the coordinate position of the operated part included in the operation information. For example, when the coordinate position of the operated part is located in a left side region of the display image data 1203 in the example of FIG. 12, the control unit 111 determines that the operation has been performed on the music selection image data 1201. In contrast, when the coordinate position of the operated part is located in a right side region of the display image data, the control unit 111 determines that the operation has been performed on the map image data 1202. Because the vehicle-mounted unit combines the display image data 1201 and 1202 whose sizes are reduced to one-half of their original sizes into display image data and then provides this display image data for the remote device 2 in the example shown in FIG. 12, the control unit controls the operation system 102 after multiplying the coordinate position of the operated part by a factor of 2, like that in accordance with Embodiment 4.

As mentioned above, because the remote control communication system in accordance with this Embodiment 5 is constructed in such a way that the vehicle-mounted unit 1 combines a plurality of display image data therein into display image data and transmits this display image data to the remote device 2, when, for example, the screen size of the remote device 2 is sufficiently larger than that of the vehicle-mounted unit 1, the remote control communication system enables the user to perform a parallel operation by displaying the plurality of display image data of the vehicle-mounted unit 1 on the remote device 2 in such a way that they are arranged in parallel to one another or they are arranged in windows, respectively, thereby being able to improve the convenience of the remote device 2. In this embodiment, there is no necessity to develop any protocol, provide any expansion for the functions of the remote device 2, and so on, and the remote device 2 can implement a remote control operation by simply having a general-purpose VNC function.

### Embodiment 6

In Embodiment 6, a case of implementing a VNC function even when rigid constraints are placed on the performance of a remote device 2, and various functions cannot be mounted in the remote device is shown. Hereafter, the present embodiment is shown particularly in a case of using a remote device 2 equipped with only an HTTP browser function (browser software) and implementing a VNC function by using an HTTP protocol corresponding to this browser software. A remote control communication system in accordance with Embodiment 6 has the same structure as that in accordance with Embodiment 1 shown in FIG. 2, and will be explained with reference to this FIG. 2.

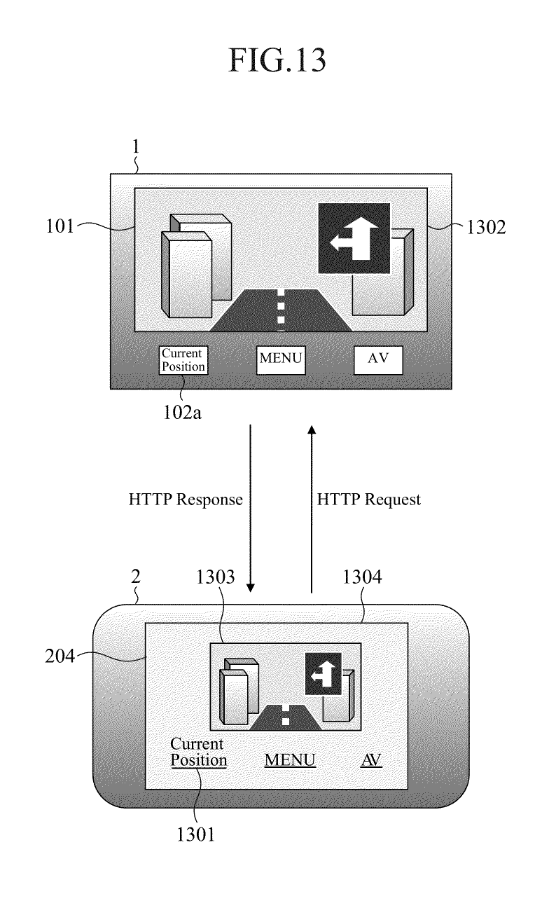

In a case in which the remote device 2 is equipped with only the HTTP browser function, when, for example, generating virtual image data imitating a physical operation system (operation buttons 102a) of the vehicle-mounted unit 1, a data generating unit 107 generates an HTML document 1301 including a hyperlink corresponding to this physical operation system, as shown in FIG. 13, in order to make the physical operation system executable by using the browser software. A data processing unit 108 then processes display image data 1302 currently being displayed on a display unit 101 into display image data 1304 which is suited to the remote device 2 by converting the display image data 1302 into an HTML image 1303 and adding the HTML document 1301 generated by the data generating unit 107 to this HTML image. The data processing unit can convert the physical operation system into an image with a hyperlink, or can superimpose a character string showing a hyperlink on the image.

By controlling in this way, even in the case in which a remote device 2 equipped with only an HTTP browser function is used, the vehicle-mounted unit can provide virtual image data imitating the physical operation system of the vehicle-mounted unit 1 for the remote device by using the HTTP protocol, thereby being able to implement a VNC function. In this embodiment, there is no necessity to provide any expansion for the functions of the remote device 2. Further, the present embodiment is considered to be effective particularly in a case in which the screen transition in the vehicle-mounted unit 1 is not complicated and is changed to an event-driven one. Although the case of generating virtual image data imitating the physical operation system is shown above, the vehicle-mounted unit can alternatively generate virtual image data in which the display form of the operation system is changed by using the method in accordance with either one of Embodiments 2 and 3.

As mentioned above, because the remote control communication system in accordance with this Embodiment 6 is constructed in such a way that even in the case in which the remote device 2 is equipped with only an HTTP browser function, the vehicle-mounted unit uses an HTTP protocol corresponding to this browser software to transmit the display image data currently being displayed on the display unit 101 and virtual image data to the remote device 2 by using an HTML image and a hyperlink, the remote control communication system can implement a VNC function even for a remote device 2 on which rigid constraints are placed.

### Embodiment 7

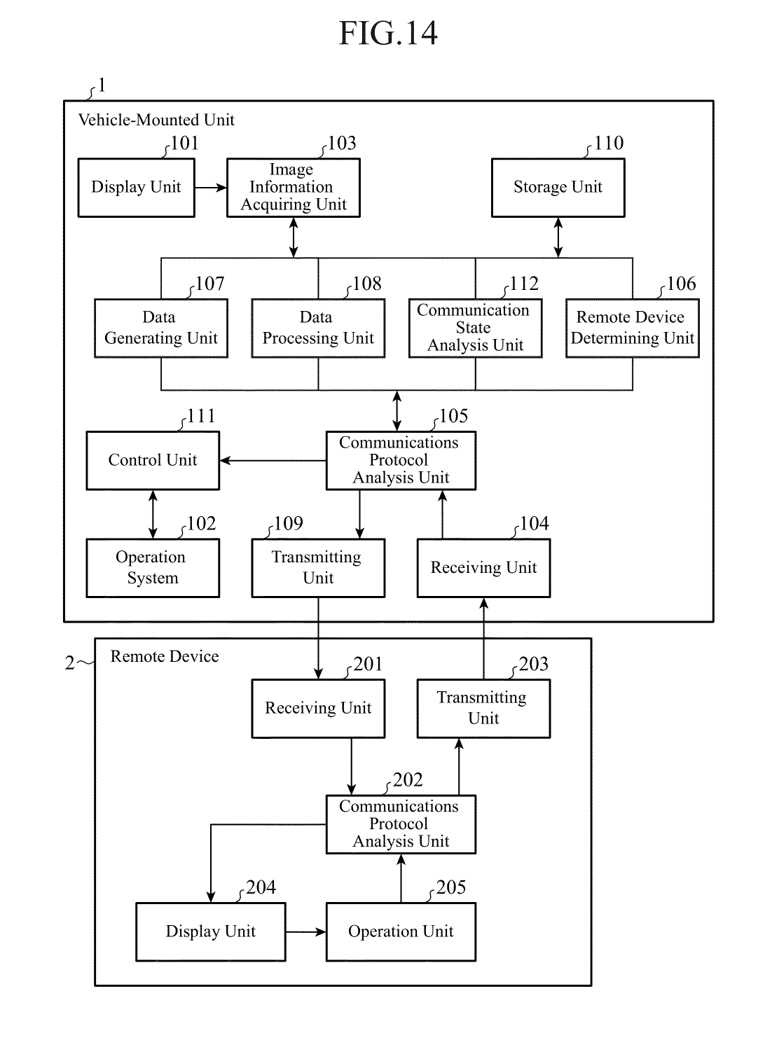

Remote control using mobile equipment having lower specs than PCs has a problem in band securing and communication processing load at a time of transmitting large-volume display image data. Therefore, a reduction in the data volume of display image data to be transmitted to a remote device 2 is needed. On the other hand, regarding a method of reducing the data volume, standard compression methods, such as JPEG and MPEG, and so on have been established. However, in the case of using the RFB protocol, because the RFB does not support JPEG, this compression method cannot be applied. Further, because advanced compression methods, such as JPEG and MPEG, require many resources, another problem is that the cost becomes high. To solve the problems, in Embodiment 7, an example of changing the display form of display image data to be transmitted according to the state of communications and implementing simple compression within the limits of a standard protocol, thereby coping with both the maintenance of connectivity and the speed of communications. A remote control communication system in accordance with Embodiment 7 shown in FIG. 14 includes a communication state analysis unit 112 in addition to the structural components of the vehicle-mounted unit 1 of the remote control communication system in accordance with Embodiment 1 shown in FIG. 2. The other structural components are the same as those of the remote control communication system in accordance with Embodiment 1 and are designated by the same reference numerals, and the explanation of the structural components will be omitted hereafter.

The communication state analysis unit 112 analyzes the state of the communications with the remote device 2. A method of analyzing the state of the communications is not limited to a specific one. For example, the state of the communications can be determined from the transmission and reception of a periodical specific packet, by using a flow control mechanism of a transmission protocol (TCP or the like) in a low order layer, or from the frequency of a response conforming to the RFB protocol from the remote device 2.

When the communication state analysis unit 112 determines that the communication speed becomes equal to or lower than a predetermined threshold, a data processing unit 108 reduces the data volume of the display image data to be transmitted to the remote device 2. At this time, the data processing unit 108 divides the display image data to be transmitted to the remote device 2 into appropriate blocks and also divides the display image data already transmitted to this remote device 2 (the display image data currently being displayed on the remote device 2) into appropriate blocks, and makes a comparison between each block of the display image data to be transmitted with the corresponding one of the display image data already transmitted. The data processing unit reduces the data volume of the display image data to be transmitted to the remote device by extracting only blocks each having a change in its pixel values therein (difference image data).

Further, a change in a strenuously moving part of the display image data cannot be caught strictly by a human being's eyes. Therefore, the data volume can be reduced by reducing the number of samples in each of which a comparison between the pixel value in a block in a strenuously moving part of the display image data to be transmitted and the pixel value in a corresponding block of the display image data already transmitted is made. A strenuously moving part of the display image data can be determined from, for example, a rate of change of each pixel or a pixel group per unit time. Further, also for apart not having any strenuous movement in the display image data, the data volume can be reduced by similarly reducing the number of samples. However, because a human being's eyes can catch a slowly moving part relatively sensitively, there is a possibility that the remote device provides a feeling that something is abnormal for the user when the display image data includes a slowly moving part.

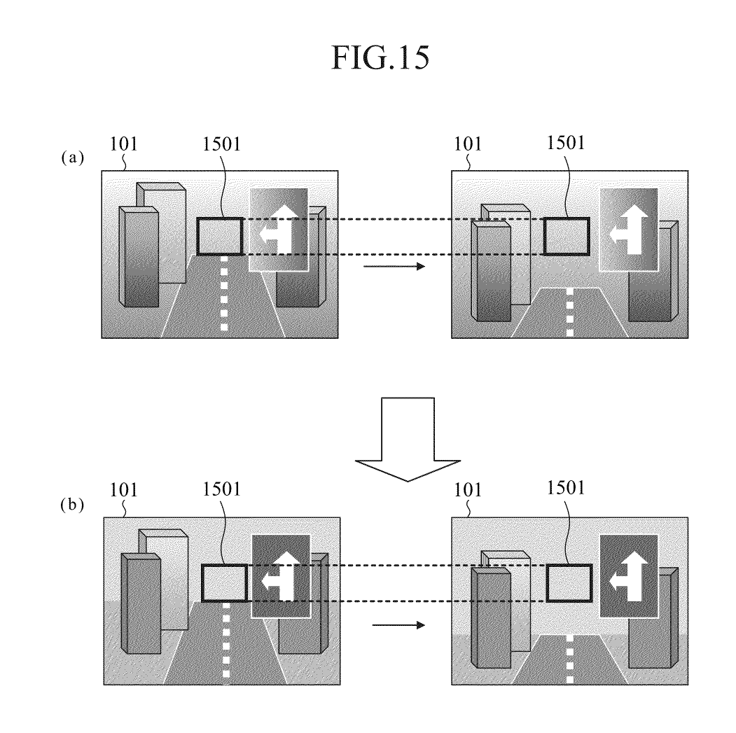

To prevent the possibility, the data processing unit 108 corrects the display image data in advance in such a way that no slowly moving part is included in the display image data. As a method of correcting the display image data, for example, there is a means for carrying out a noise eliminating process, such as a smoothing filter or a median filter, on the display image data to reduce changes in the color of each block as much as possible. For example, FIG. 15(a) shows the display image data currently being displayed on the display unit 101 in which the color of a predetermined block 1501 (the color of the sky) has a gradation. Therefore, the color of this predetermined block 1501 slightly changes as the vehicle equipped with the vehicle-mounted unit travels. To solve this problem, the data processing unit carries out the noise eliminating process on the display image data to fill in the sky with a single color, as shown in FIG. 15(b), thereby preventing any change from occurring in the color of the block 1501 even if the vehicle travels. As a result, it becomes unnecessary to transmit the image data within the block 1501 to the remote device 2, and the data volume can be reduced.

Further, by changing the number of colors, the data processing unit can reduce the data volume. In a case of True color, while 24 bits (32 bits) per pixel of information is needed, the amount of transmission can be reduced to one-half of the original amount of transmission by reducing the quality of the image and using 16 bit colors. By dynamically changing the number of colors according to conditions for applying this process to a strenuously moving part of the display image data, an average screen frame update rate can be improved. The data received in the form of 16 bit colors can be displayed as a 16 bit color image by the remote device 2 which has received the data or can be shifted 16 bits and displayed as a 32-bit color image by the remote device 2.

When the communication state analysis unit 112 determines that the communication speed has returned to the predetermined threshold or more, the data processing unit 108 stops the data volume reducing process on the display image data to be transmitted to the remote device 2, and returns the display image data to its normal state.

As mentioned above, because the remote control communication system in accordance with this Embodiment 7 is constructed in such a way that the vehicle-mounted unit transmits only a region having a movement in the display image data when the speed of the communications with the remote device 2 becomes equal to or lower than the predetermined threshold, the remote control communication system can reduce the data volume transmitted to the remote device 2, thereby being able to improve the ease of use of the remote device 2 also when the remote device 2 has low specs. Further, by carrying out the noise eliminating process on the display image data, reducing the number of colors, and so on, the vehicle-mounted unit can further reduce the data volume.

### Embodiment 8

In Embodiment 8, an embodiment of providing a noticeable speed improvement when transmitting display image data to a remote device 2 will be shown. A remote control communication system in accordance with Embodiment 8 has the same structure as that in accordance with Embodiment 7 shown in FIG. 14, and will be explained with reference to this FIG. 14.

A data processing unit 108 divides display image data to be transmitted to the remote device 2 into a plurality of data on the basis of a type determination result acquired by a remote device determining unit 106, image information acquired by an image information acquiring unit 103, and so on, and extracts each of the plurality of data into which the display image data are divided (divided image data) in a predetermined transmission order. Further, a transmitting unit 109 transmits the divided image data extracted by the data processing unit 108 to the remote device 2.

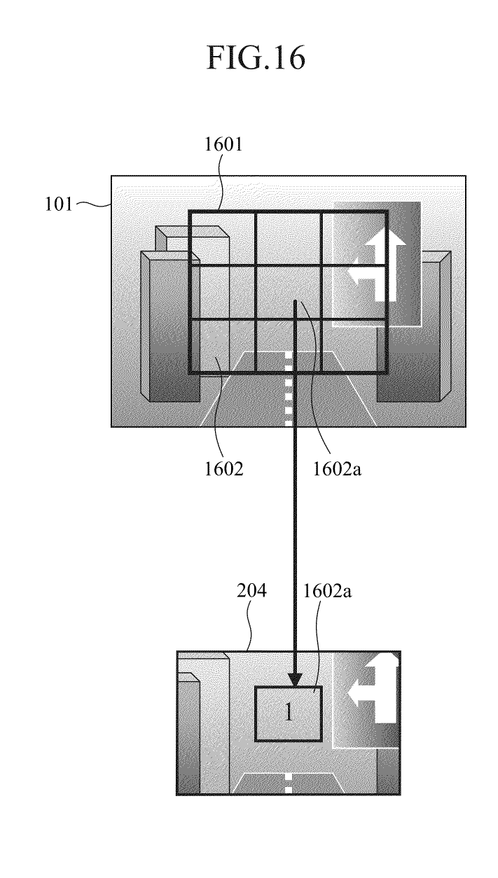

When the screen size of the remote device 2 is smaller than that of the vehicle-mounted unit 1, the remote device 2 cannot display all of the display image data currently being displayed on the display unit 101 while maintaining the resolution of the display image data. Therefore, as shown in, for example, FIG. 16, when transmitting display image data in a screen region 1601 which has been requested by the remote device 2, the data processing unit 108 divides this display image data into a plurality of blocks 1602. The data processing unit then extracts the divided image data located at the center of the display unit 204 of the remote device 2 first, and then transmits the divided image data to the remote device via a transmitting unit 109. After that, the data processing unit extracts and transmits each of the remaining divided image data in descending order of their distances to the screen edge portion.

As mentioned above, because the remote control communication system in accordance with this Embodiment 8 is constructed in such a way that the vehicle-mounted unit divides the display image data to be transmitted to the remote device 2 into a plurality of divided image data and extracts each of the plurality of divided image data in ascending order of their distances from the central position, i.e., in descending order of their distances to the screen edge portion, the remote control communication system can display the data in the central portion of the screen to which the user pays attention mostly immediately when the screen is updated without changing the amount of the transmitted screen display data, thereby being able to provide a noticeable speed improvement. Further, because the noticeable speed is improved, the remote control communication system can extend a permissible range in which the transmission throughput can be reduced, and can also reduce the communication band while maintaining the ease of use of the remote device.

### Embodiment 9

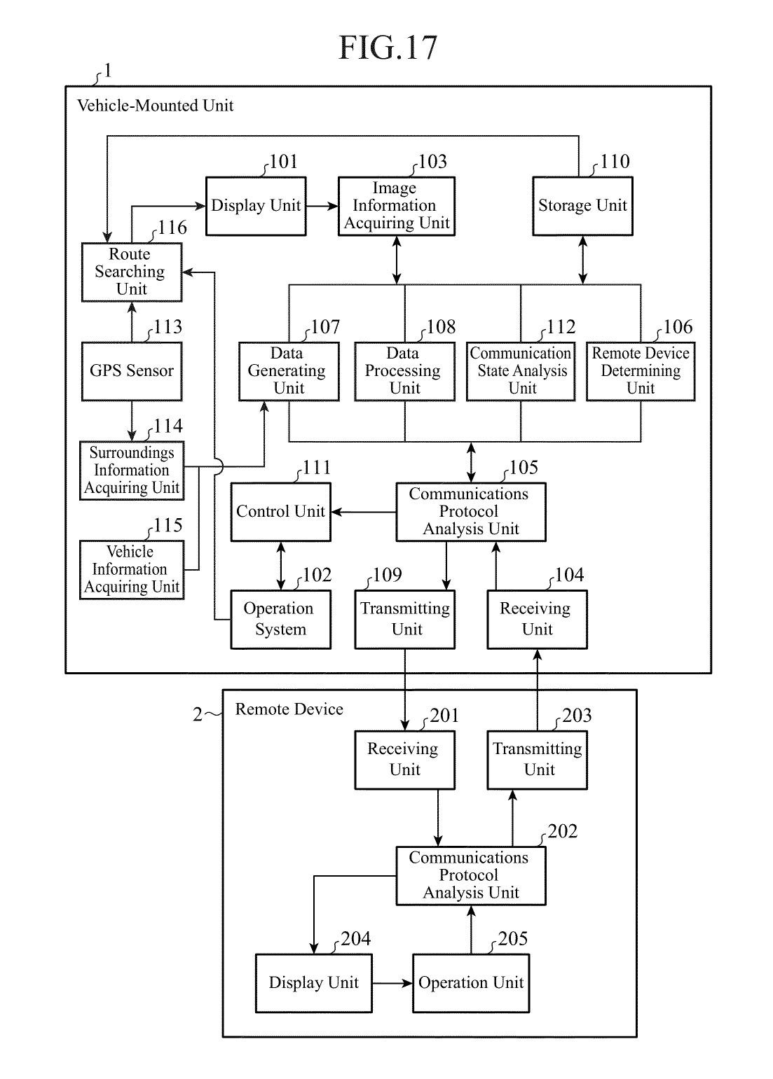

In Embodiment 9, an embodiment of expressing each of pieces of information including sightseeing information, traffic information, and information about a vehicle, which are acquired by various information acquiring units disposed in a vehicle-mounted unit 1, by using virtual image data, and then transmitting the virtual image data to a remote device 2 is shown. A remote control communication system in accordance with Embodiment 9 shown in FIG. 17 includes a GPS (Global Positioning System) sensor 113, a surroundings information acquiring unit 114, a vehicle information acquiring unit 115, and a route searching unit 116 in addition to the structural components of the vehicle-mounted unit 1 of the remote control communication system in accordance with Embodiment 7 shown in FIG. 14. The other structural components are the same as those of the remote control communication system in accordance with Embodiment 7 and are designated by the same reference numerals, and the explanation of the structural components will be omitted hereafter.

The GPS sensor 113 measures the position of the vehicle by receiving radio waves from a plurality of GPS satellites. The surroundings information acquiring unit 114 acquires information about the vehicle's surroundings (sightseeing information about the vehicle's surroundings, traffic information from VICS (Vehicle Information and Communication System) and so on which are based on the vehicle position measured by the GPS sensor 113 and map data stored in a storage unit 110).

The vehicle information acquiring unit 115 acquires information about the vehicle (speed information, fuel information, and so on). The route searching unit 116 performs a search for a route to a destination, which is inputted by a user via an operation system 102, on the basis of the vehicle position measured by the GPS sensor 113. The route which is searched for by this route searching unit 116 is drawn on map image data stored in the storage unit 110, and is displayed on a display unit 101.

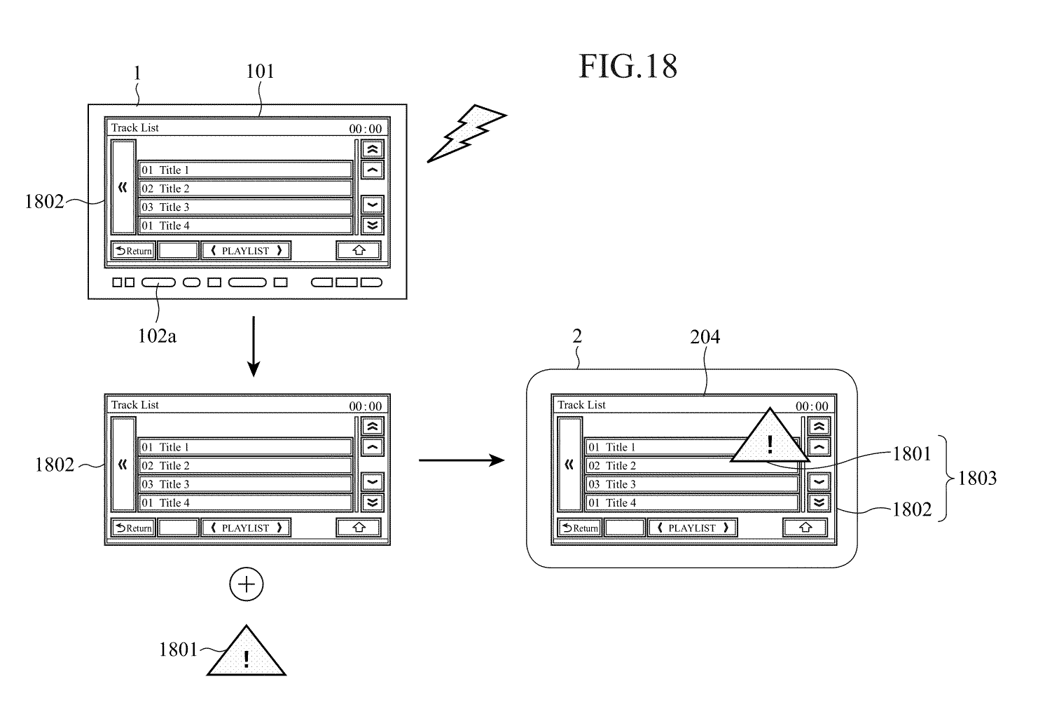

A data generating unit 107 dynamically generates virtual image data expressing the various pieces of information acquired by the surroundings information acquiring unit 114 and the vehicle information acquiring unit 115 by using data parts stored in the storage unit 110. For example, in FIG. 18, a case of, when traffic warning information showing the occurrence of a traffic jam, an accident, or the like is acquired by the surroundings information acquiring unit 114, generating warning image data 1801 expressing this traffic warning information is shown. A data processing unit 108 then transmits display image data 1803 in which the warning image data 1801 is superimposed on the display image data 1802 currently being displayed on the display unit 101 to the remote device 2. In addition to this warning image data, the data processing unit can add virtual image data expressing the sightseeing information acquired by the surroundings information acquiring unit 114 to the display image data, for example. Further, the data processing unit can add speed meter image data showing the speed information acquired by the vehicle information acquiring unit 115, warning image data showing a warning of excessive speed, fuel meter image data showing fuel information, or the like to the display image data.

As mentioned above, because the remote control communication system in accordance with this Embodiment 9 is constructed in such a way that the vehicle-mounted unit 1 expresses each of pieces of information which are acquired by the information acquiring units 114 and 115 mounted thereto by using virtual image data, and transmits the virtual image data to the remote device 2, the remote control communication system can provide sightseeing information about the vehicle's surroundings, traffic information, information about the vehicle, and so on also for the remote device 2. Although the case of expressing the various pieces of information acquired by the surroundings information acquiring unit 114 and the vehicle information acquiring unit 115 by using virtual image data is shown in Embodiment 9, this embodiment is not limited to this example. The present embodiment can be applied similarly to information acquired by any other information acquiring unit. Further, although the explanation is made in Embodiment 9 by using a navigation device used for vehicles as the vehicle-mounted unit, the present embodiment can be applied to a navigation device for any other moving object. For example, the present embodiment can be applied similarly to a navigation device for pedestrians, such as a mobile phone.

Further, although the case of remotely controlling the vehicle-mounted unit 1 by using the remote device 2, such as a mobile terminal, is shown in Embodiments 1 to 9, these embodiments are not limited to this example. For example, these embodiments can be applied similarly to a case of remotely controlling any other navigation device by using a remote device, and to a case of remotely controlling a mobile terminal by using another mobile terminal. In addition, while the invention has been described in its preferred embodiments, it is to be understood that an arbitrary combination of two or more of the embodiments can be made, various changes can be made in an arbitrary component in accordance with any one of the embodiments, and an arbitrary component in accordance with any one of the embodiments can be omitted within the scope of the invention.

### INDUSTRIAL APPLICABILITY

The remote control communication device and the navigation device in accordance with the present invention can eliminate the necessity to develop any protocol and provide any expansion for the functions of a remote device when implementing a VNC function by using a device which is different from PCs and which is not standard, and can improve the connectivity and the ease of use of the remote device. Therefore, the remote control communication device and the navigation device in accordance with the present invention are suitable for use as a remote control communication device or the like which can be controlled remotely by a remote device, and a navigation device or the like to which this remote control communication device is applied, respectively.

### EXPLANATIONS OF REFERENCE NUMERALS

1 vehicle-mounted unit (remote control communication device or navigation device), 2 remote device, 101 display unit, 102 operation system (operation unit), 102a operation buttons, 103 image information acquiring unit, 104 receiving unit (communication unit), 105 communications protocol analysis unit, 106 remote device determining unit, 107 data generating unit, 108 data processing unit, 109 transmitting unit (communication unit), 110 storage unit, 111 control unit, 112 communication state analysis unit, 113 GPS sensor, 114 surrounding information acquiring unit, 115 vehicle information acquiring unit, 116 route searching unit, 201 receiving unit, 202 communications protocol analysis unit, 203 transmitting unit, 204 display unit, 205 operation unit.

1. A remote control communication device comprising:
a display unit for displaying image data;
an image information acquiring unit for acquiring image information about the image data displayed on a screen of said display unit;
a communication unit for carrying out communications with a remote device;
a remote device determining unit for determining a type of said remote device;
a data generating unit for generating virtual image data imitating an interface of the remote control communication device, the interface not existing in the remote device of the type determined by said remote device determining unit, in such a way that the interface can be operated in said remote device;
a data processing unit for processing image data for remote devices in which the virtual image data generated by said data creating unit are included in the image data of said display unit which is shown by the image information acquired by said image information acquiring unit in such a way that said image data for remote devices is suited to a display screen of the remote device of the type determined by said remote device determining unit, and for transmitting said processed image data for remote devices to said remote device by using said communication unit; and
a control unit for, when said communication unit receives operation information about an operation which is performed on a basis of said image data for remote devices in said remote device, performing an operation in the interface of the remote control communication device according to said operation information.

2. The remote control communication device according to claim 1, wherein said data generating unit generates virtual image data imitating an operation unit which does not exist in the remote device of the type determined by said remote device determining unit and which is disposed outside the screen of said display unit in such a way that the operation unit can be operated in said remote device, and, when said communication unit receives operation information about an operation performed in said remote device on a basis of said image data for remote devices, said control unit performs an operation in said operation unit according to said operation information.

3. The remote control communication device according to claim 2, wherein said data generating unit generates the virtual image data imitating the operation unit disposed outside the screen of said display unit by changing a display form of said operation unit.

4. The remote control communication device according to claim 1, wherein said data generating unit generates image data different from the image data of said display unit, and said data processing unit processes the image data generated by said data generating unit, as the image data for remote devices, in such a way that the image data is suited to the display screen of the remote device of the type determined by said remote device determining unit.

5. The remote control communication device according to claim 1, wherein said data processing unit changes a screen size of said image data for remote devices to a screen size suited to the display screen of said remote device.

6. The remote control communication device according to claim 1, wherein said data generating unit generates virtual image data including a plurality of image data which can be displayed on the screen of said display unit.

7. The remote control communication device according to claim 1, wherein said data generating unit generates virtual image data imitating the interface of said remote control communication device, the interface not existing in the remote device of the type determined by said remote device determining unit, in such a way that the interface can be operated in said remote device by using browser software with the virtual image data being executable, and said communication unit transmits said image data for remote devices to said remote device by using a protocol corresponding to said browser software.

8. The remote control communication device according to claim 1, wherein said remote control communication device includes a communication state analysis unit for analyzing a state of the communications with the remote device by said communication unit, and said data processing unit changes a display form of said image data for remote devices according to the communication state analyzed by said communication state analysis unit.

9. The remote control communication device according to claim 8, wherein when said communication state analysis unit determines that a communication speed becomes equal to or lower than a predetermined threshold, said data processing unit extracts data of a region having a change between the image data for remote devices to be transmitted to said remote device and the image data for remote devices currently being displayed on said remote device as difference image data, and transmits the difference image data to said remote device by using said communication unit.

10. The remote control communication device according to claim 9, wherein said data processing unit carries out a noise eliminating process or/and reduction of a number of colors on said image data for remote devices.

11. The remote control communication device according to claim 1, wherein said communication unit divides said image data for remote devices into a plurality of blocks, and transmits each of said plurality of blocks to said remote device in ascending order of their distances from a central position of the display screen of said remote device, i.e., in descending order of their distances to a screen edge portion of the display screen of said remote device.

12. A navigation device disposed in a moving object and provided with the remote control communication device according to claim 1, wherein said data generating unit generates virtual image data imitating an interface of said navigation device used for navigation processing in such a way that the interface can be operated in said remote device, said data processing unit processes the image data for remote devices in which the virtual image data generated by said data generating unit is included in the image data of said display unit which is shown by the image information acquired by said image information acquiring unit in such a way that the image data for remote devices is suited to the display screen of the remote device of the type determined by said remote device determining unit, said communication unit transmits the image data for remote devices to said remote device, and, when said communication unit receives operation information about an operation performed in said remote device on a basis of said image data for remote devices, said control unit performs an operation in the interface of said navigation device according to said operation information.

13. The navigation device according to claim 12, wherein said navigation device includes an information acquiring unit for acquiring sightseeing information about said moving object's surroundings, traffic information about said moving object's surroundings, or information about said moving object, and the data generating unit generates virtual image data expressing the information acquired by said information acquiring unit.
